(19) United States
(12) Patent Application Publication
(10) Pub. No.: US 2004/0246920 A1
(43) Pub. Date: Dec. 9, 2004

(54) Transmission of pricing information in telecommunication system

(75) Inventor: Teemu Savolainen, Tampere (FI)

Correspondence Address: Crawford Maunu PLLC, Suite 390, 1270 Northland Drive, St. Paul, MN, 55120, US

(73) Assignee: Nokia Corporation

(21) Appl. No.: 10/854,395

(22) Filed: May 26, 2004

(30) Foreign Application Priority Data
Jun. 3, 2003 (FI) 20030827

(51) Int. Cl. H04Q 7/00

(52) U.S. Cl. 370/328

(57) ABSTRACT

An arrangement for providing a terminal with information on the price of using a wireless telecommunication network, comprising at least one wireless telecommunication network, a terminal, which is within the coverage area of said at least one telecommunication network. The telecommunication network comprises means for forming pricing information on using the telecommunication network for data transmission, the terminal is configured to receive from said at least one telecommunication network the pricing information on using the telecommunication network for data transmission, and the terminal comprises a control unit controlling different parts of the terminal, the control unit being configured to form control information for selecting a telecommunication network to be used for data transmission on the basis of the pricing information received from said at least one telecommunication network.

### FIELD

The invention relates to providing a terminal communicating with a telecommunication network with information on the price of the connection.

### BACKGROUND

As telecommunication networks become more common and they require much capacity, it is natural that specific geographical areas use several, at least partly overlapping telecommunication networks. Overlapping networks can include, for instance, networks of different operators, utilising the same technology, or networks utilising different technologies. A terminal has thus the possibility of selecting the telecommunication network to be used as desired. One criterion in selecting a network is, naturally, the price of using the network.

According to the prior art, if a user wants to compare the prices of different telecommunication networks, he can acquaint himself with advertisements of different operators or inquire the price of a service provided by an operator by phone. It is obvious that this is not a very flexible way and inquiry calls cause extra load in networks.

### BRIEF DESCRIPTION

It is an object of the invention to provide a method and an arrangement implementing the method such that the number of price inquiry calls can be decreased and the load of a telecommunication network can thus be reduced. This is achieved by a method of transmitting pricing information to a terminal using a wireless telecommunication network. The method comprises connecting the terminal to at least one wireless telecommunication network, receiving at the terminal from at least one telecommunication network pricing information on using the telecommunication network for data transmission, and deciding, on the basis of the pricing information received at the terminal, whether the telecommunication network is used for data transmission.

The invention also relates to an arrangement for providing a terminal with information on the price of using a wireless telecommunication network, comprising at least one wireless telecommunication network, each telecommunication network comprising a transceiver for forming a radio connection to terminals in the coverage area of the telecommunication network, a terminal, which is within the coverage area of said at least one telecommunication network, the terminal comprising a transceiver for forming a radio connection to the transceiver of at least one telecommunication network. The telecommunication network comprises means for forming pricing information on using the telecommunication network for data transmission, the transceiver of the terminal is configured to receive from said at least one telecommunication network the pricing information on using the telecommunication network for data transmission, and the terminal comprises a control unit controlling different parts of the terminal, the control unit being configured to form control information for selecting a telecommunication network to be used for data transmission on the basis of the pricing information received from said at least one telecommunication network.

The invention also relates to a terminal, which comprises a transceiver for forming a radio connection to at least one wireless telecommunication network, the transceiver being configured to receive from said at least one telecommunication network pricing information on using the telecommunication network for data transmission, and the terminal comprises a control unit, the control unit being configured to form control information for selecting a telecommunication network to be used for data transmission on the basis of the pricing information received from said at least one telecommunication network.

The invention also relates to a wireless telecommunication network comprising a transceiver for forming a radio connection to a terminal using the telecommunication network. The telecommunication network comprises means for forming pricing information on using the telecommunication network for data transmission, and the transceiver is configured to transmit the pricing information on using the telecommunication network for data transmission to the terminal in radio connection with the telecommunication network.

Preferred embodiments of the invention are disclosed in the dependent claims.

The invention is based on transmitting information on the price of using one or more wireless telecommunication networks to a terminal using a telecommunication network before starting the actual data transmission. In this context, data transmission refers to a call, file loading, Internet browsing or the like. In the description of the invention, a terminal refers to a mobile phone or a portable computer connected to a mobile phone, for example. A wireless telecommunication network refers to, for instance, a mobile communication network, a WLAN network or a Bluetooth network. A telecommunication network provides data transmission possibilities for terminals connected thereto.

Transferring of pricing information to a terminal means that during a connection set-up, e.g. at the signalling stage, information on the price of using a telecommunication network is transferred to a terminal. On the basis of the pricing information received, the terminal decides whether the terminal is connected to this telecommunication network for the actual data transmission connection. The terminal thus receives the information on the price of the network in advance, i.e. before the actual data transmission is started. In an embodiment, pricing information of one or more telecommunication networks is presented to the user of the terminal and the user can select the most inexpensive telecommunication network available. In a second embodiment, the terminal is automatically connected to the most inexpensive telecommunication network available. In an embodiment, the terminal automatically disconnects the connection to the telecommunication network, if the price of using the network is higher than the pre-set threshold value.

In an embodiment, the pricing information of the telecommunication network is transferred to the user by means of a message belonging to the IP (Internet Protocol). This provides the advantage that as more and more telecommunication networks are based on IP technology, information can be transferred from different networks by applying the same principles.

The method and system of the invention provide the advantage that as there are fewer inquiry calls, the load of the network is reduced.

### LIST OF FIGURES

In the following the invention will be described in greater detail in connection with preferred embodiments, with reference to the accompanying drawings, in which

FIG. 1 shows an embodiment of the method,

FIG. 2 shows a signalling diagram for transmitting pricing information to a terminal,

FIG. 3 shows an embodiment of a data structure used for transmitting pricing information,

FIG. 4 illustrates the structure of the data structure used for transmitting pricing information,

FIG. 5 shows a signalling diagram of a situation according to a second embodiment,

FIG. 6 shows an embodiment of a telecommunication network, and

FIG. 7 shows an arrangement for implementing the invention.

### DESCRIPTION OF THE EMBODIMENTS

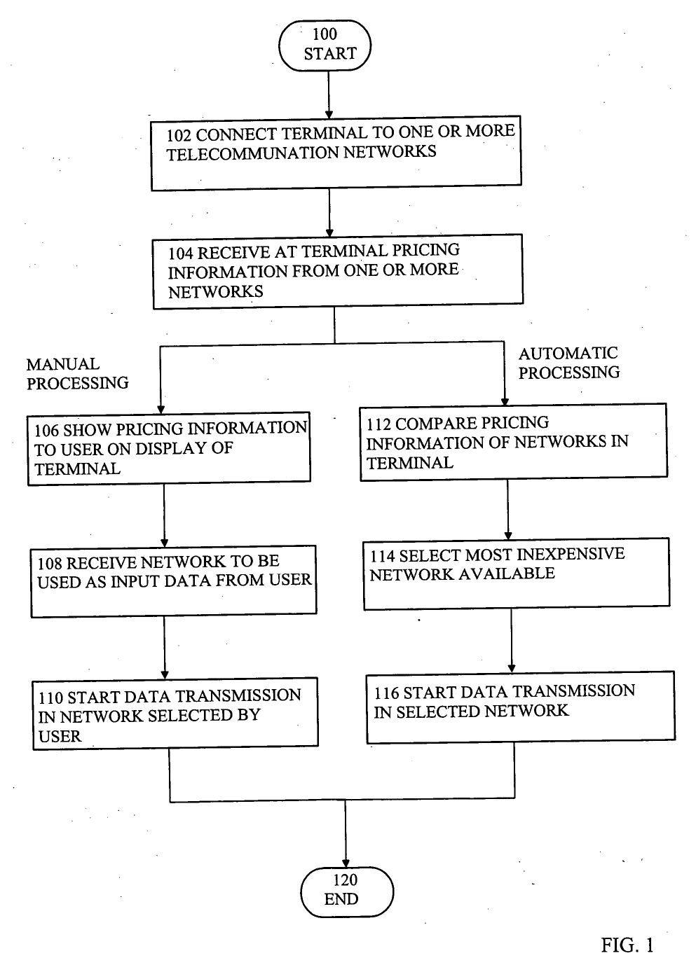

FIG. 1 shows an embodiment of the method according to the invention. At the initial stage 100 of the method, a terminal, such as a mobile phone, is within the coverage area of at least one wireless telecommunication network, such as a mobile communication network. A mobile station can have a functionality of displaying networks available to a user on its display. In method step 102, the terminal is connected to one or more networks in whose coverage area the terminal is. In this context, the connecting refers to a connection set-up stage of a telecommunication connection before the actual data transmission stage.

In method step 104, pricing information is transmitted to the terminal from each at least one telecommunication network in whose coverage area the terminal is. The information on the price of using the telecommunication network can be transmitted automatically from the network when the terminal arrives at the coverage area of an available telecommunication network, or the pricing information is transferred to the terminal when the terminal is connected to the network in order to acquire an IP address, for instance. The network can transmit the pricing information to the terminal also when the price of the data transmission stage changes. The price may rise because the load of the network increases, for example. On the other hand, the price may fall when, for instance, night or weekend tariffs are taken into use. Further, pricing information can be transmitted from one or more networks also when the connection between the terminal and the telecommunication network is disconnected, in which case the pricing information can be transmitted from other available networks. Furthermore, pricing information can be transmitted from networks also periodically, whereby the terminals continually receive real-time information on the prices of different networks.

FIG. 1 further shows two possible ways of processing the pricing information with a terminal. The first step 106 of the branch of manual processing is that pricing information is shown to a user on the display of the terminal. The pricing information is shown on the display according to step 106 for example so that a network identifier, technical implementation (such as WLAN, GPRS), the price of data transmission in the network and possibly also the operator are displayed to the user. The price can be expressed, for instance, as a price per one megabyte, time unit or data packet. The pricing information can also include specified prices for transmitted data and received data.

In method step 108 the user selects the network which he wants to use in the actual data transmission stage of the connection. In this context, the use refers to file loading or a call, for instance. The user can select the network to be used for instance such that a list of networks, from which the user can select the desired network by using the keyboard of the terminal, is displayed on the display of the terminal.

In method step 110, the terminal and the network carry out the necessary procedures to start the data transmission in the network selected by the user. If the price of using the network is based on time, the charging for using the network starts when data transmission starts.

Method steps 112 to 116 illustrate the automatic selection of a telecommunication network by the terminal. Before the automatic processing, the user may, by using the terminal, select a setting option according to which the terminal uses the most inexpensive network, if possible. The terminal can be used for also setting other criteria to the network, such as sufficient data transmission capacity, sufficient quality, etc. In method step 110, the pricing information received in step 104 is compared in the terminal. In step 114, the most inexpensive network is selected in the terminal and in step 116, the terminal automatically changes to the most inexpensive network. When the terminal changes to the most inexpensive network, it may also disconnect the previous connection, which means that only the network used in the connection changes.

FIG. 1 shows an embodiment of the method according to the invention on the basis that a terminal, which does not yet have a telecommunication connection to any telecommunication network, starts to set up a connection. The basic idea of the method can also be applied to a situation where the terminal already has a data transmission connection and the terminal arrives at the coverage area of a new telecommunication network. In this case, the user of the terminal can be informed of another available network by means of an acoustic signal, for instance, and the price of using the other telecommunication network can be shown on the display of the terminal. The user is thus provided with a possibility of changing the network used for data transmission, if desired.

Yet another example of application is when the price of the connection changes. Then, the user of the terminal is provided with a possibility of deciding whether he wants to continue to use the connection in spite of a changed, e.g. increased price. Furthermore, another application of the method is that a connection used for data transmission is disconnected, whereby the user of the terminal is provided with a possibility of selecting between the networks to which the terminal is connected.

Although the terminal has a data transmission connection to a wireless telecommunication network, the terminal can also be simultaneously connected to one or more other networks and can thus observe potential changes in the prices of these networks. By means of the terminal, the user can thus be provided with a possibility of changing the telecommunication network which is used for data transmission, even though the data transmission connection would not have been broken or the price of the connection would not have been changed.

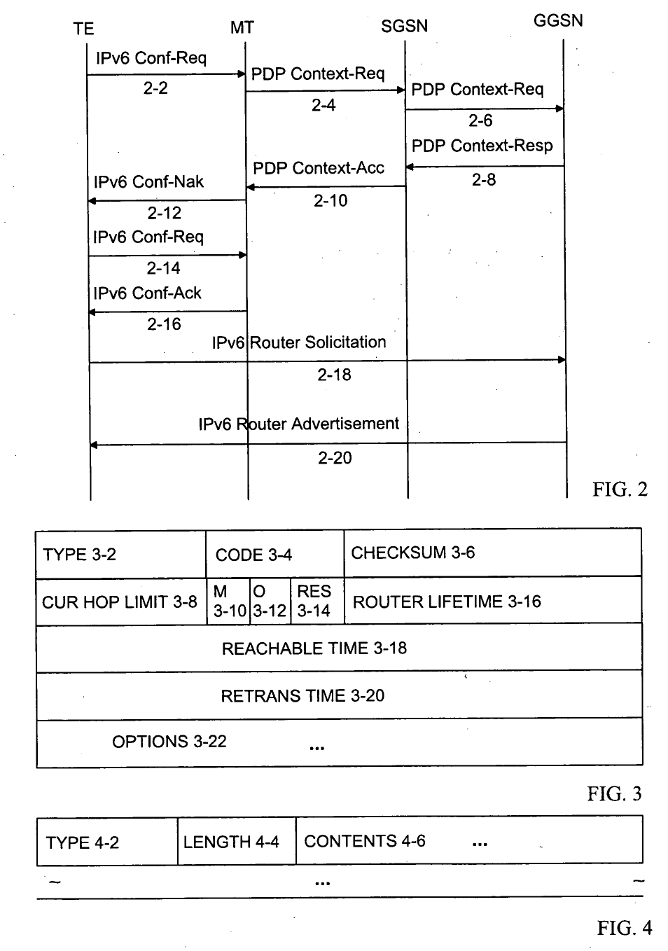

FIG. 2 shows an embodiment of how terminal equipment TE can receive pricing information from the network. FIG. 2 illustrates signalling according to the IP protocol version 6 (IPv6). In FIG. 2, TE refers to terminal equipment and MT to a mobile terminal, which means that in a conventional mobile station, the TE and the MT are in the same device but in case of a portable computer, for instance, the portable computer can be considered to comprise a TE functionality and a mobile station connected to the portable computer can be considered to comprise mobile station functionalities MT. In the initial step of the process, the TE forms an IPv6CP Configure-Request message 2-2. The message 2-2 is preceded by a handshaking stage, which is not described herein for the sake of clarity. In the mobile terminal MT, this results in an Activate PDP Context Request message 2-4, which is transmitted to the SGSN (Serving GPRS Support Node) of the GPRS (General Packet Radio Services) network used in the example. In the GPRS network, the SGSN is responsible for mobility management, safety functions and routing, for instance. By using the received message, the SGSN forms a Create PDP Context Request message 2-6, which is transmitted to the GGSN (Gateway GPRS Support Node) of the GPRS network. The GGSN selects a 64-bit identifier, which is individual in a subnet at that moment. The GGSN generates a Create PDP Context Response message 2-8, which is forwarded by the SGSN to the MT in an Activate PDP Context Accept message 2-10 and transmitted by the MT to the TE in an IPv6CP Configure-Nak message 2-12. The Configure-Nak message indicates that the suggestion transmitted by the TE in the IPv6CP Configure-Request 2-2 and concerning the identifier to be used, which can be an undefined (O) or other identifier, e.g. a random identifier or an identifier generated from a serial number, is not good, but that the TE should use the identifier obtained from the network and indicated in the IPv6CP Configure-Nak 2-12. After receiving the IPv6CP Configure-Nak 2-12, the TE retransmits the IPv6CP Configure-Request 2-14, which the TE has provided with the identifier it has obtained in the IPv6CP Configure-Nak 2-12. After this, the MT replies to the TE with an IPv6CP Configure-Ack 2-16, which includes the identifier obtained from the network.

As a result of the above signalling beginning with the message 2-2 and ending with the message 2-16, the terminal has obtained a link-local IP address. Thereafter, the terminal transmits an IPv6 Router Solicitation message 2-18 and receives an IPv6 Router Advertisement message 2-20 as a reply. The Router Advertisement message 2-16 contains a subnet prefix, which the terminal can start to use in order to form a global or a site-local IPv6 address. The GGSN provides each PDP Context with a unique subnet prefix, by which it can be secured that the same IP address is not allocated twice.

At regular intervals, routers of the IPv6 network transmit Router Advertisement messages, on the basis of which the terminal can check the price and notice a potential change in the prices. On the other hand, if the price changes, the router can, if desired, transmit the Router Advertisement immediately in order to inform the network users of the change in the situation as soon as possible.

After receiving the Router Advertisement message 2-20 and the IP address, the terminal can start the data transmission. In some networks, e.g. Ethernet, before the data transmission is started, the terminal ensures after the Router Advertisement that the IP address formed by the terminal has not already been allocated for some other terminal (Duplicate Address Detection process).

FIG. 3 illustrates the data structure of the IPv6 Router Advertisement message 2-16 of FIG. 2. It is to be noted that the visual lengths of the fields in FIG. 3 do not necessarily correspond to the real lengths of the fields. In an eight-bit type field 3-2, a constant value 134 is transferred and also in an eight-bit code field 3-4, a constant value 0 is transferred. Field 3-6 has a length of 16 bits and it contains checksum information. Field 3-8 contains an integer indicating which value should be set by the TE in a Hop Limit field of IP packets to be transmitted. The field is applied in such a manner that when an IP packet roams in the network, each router decreases the value of this field by one, and if the value becomes zero, the router drops the packet. One-bit fields 3-10 and 3-12 specify the mechanism of forming an IP address. After a reserved field 3-14 which is so far unused, the Router Advertisement message contains a 16-bit field 3-16 indicating how long the router can be used as a default router. Fields 3-18 and 3-20 are time fields, which are used for securing the functioning of connections between the apparatuses of the IP network.

A message can contain many option fields 3-22. An example of options is, for instance, information on one or more subnet prefixes which the network link uses and which the TE can use for forming its own address, for example. When receiving the message, receivers should discard the options they do not recognise. In spite of a possible discardment of the option, the receiver must continue to process the message and it must not transmit any notice concerning the unknown option.

FIG. 4 illustrates the structure of an option field according to an embodiment of the invention. A pricing information field 4-2, which has a length of 8 bits, describes the option type as a numeral value. A length field 4-4 describes the option length as an 8-bit number. The actual payload information, i.e. the content 4-6 of the option can consist of the information described below, for instance.

Pricing accuracy, 1 bit:

0—estimated price

1—exact price

Pricing scope, 1 bit:

0—pricing covers all data

1—pricing covers data sent from subnets advertised in this RA

Pricing type, 6 bits as decimal number:

0—no charge

1—per kilobyte transferred

2—per kilobyte sent

3—per kilobyte received

4—per megabyte transferred

5—per megabyte sent

6—per megabyte received

7—per second

8—other

Currency, 8 bits:

0—local currency

1—EUR

2—USD

3 . . . 255 other

Monetary value, 32 bits, hexadecimal:

0x0000 free

0x0001-0xFF00 monetary value

0xFF01-0xFFFE reserved

0xFFFF price unknown.

Naturally, the above structure of the option field of the Router Advertisement message is not tightly confined to the above embodiment but it can be modified in various ways.

Although the transmission of pricing information is described above in connection with a Routing Advertisement message associated with the Neighbor Discovery process, the pricing information can also be transmitted to a terminal in other messages according to the IP protocol. An example is DHCP (Dynamic Host Configuration Protocol), which is an Internet protocol for configuring terminals using the Internet protocol TCP/IP. The DHCP can be used, for instance, for automatic allocation of IP addresses and for transmitting configuration parameters, such as subnet mask and default router information, of a TCP/IP stack. The DHCP can also be used for providing configuration information, such as addresses of printer, time and news servers. Messages according to the DHCP protocol, such as a DHCPv6 protocol, have a similar basic structure, which means that a message contains a field indicating the message type, a transaction identity and a dynamic number of option parameters. The option parameter of the message according to the DHCP protocol can be implemented by applying the same principles as in case of the option parameter described above in connection with the Router Advertisement message, which means that the option parameter comprises the option type, the option length and the data content of the option.

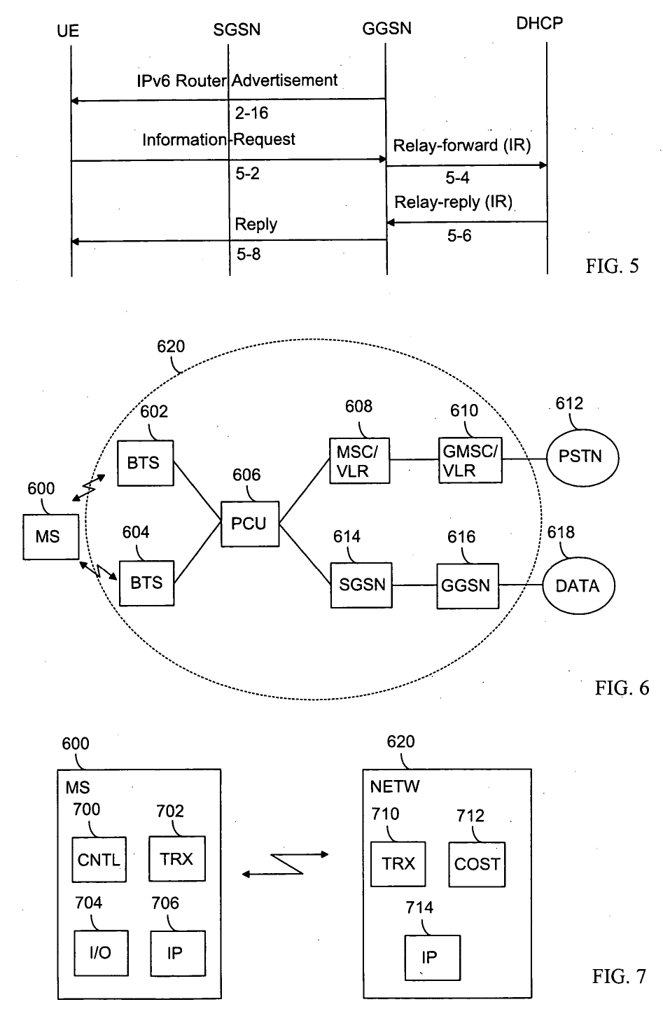

FIG. 5 illustrates an application according to the DHCP. After receiving the IPv6 Router Advertisement message 2-20, the terminal can request configuration information of the network by means of an Information Request inquiry directed to a DHCP server. If the invention is applied to FIG. 5, the inquiry message 5-2 would thus indicate that the terminal inquires the price of using the network. The GGSN, which thus functions as a DHCP Relay Agent, forwards the inquiry message 5-2 to the DHCP server as a forwarded message 5-4. The GGSN, for its part, receives a reply message 5-6 from the DHCP server and forwards it in a reply message 5-8 to the terminal that has made the inquiry.

FIG. 6 illustrates the structure of a GPRS network 620 shown as an example. The coverage area of the network 620 comprises a terminal 600, which can move in the area of the network 620 between base stations 602 and 604 or communicate with both base stations simultaneously. The base stations 602, 604 communicate with a PCU (Packet Control Unit) 606, which, for instance, manages radio channel allocation and is responsible for data packet segmentation. A visitor location register/mobile services switching centre 608, for its part, routes calls and manages roamer information. In the GPRS network, a gateway mobile services switching centre 610 routes calls between the GPRS network and other telecommunication networks, such as PSTN (Public Services Telephony Network) 612.

The PCU 606 also communicates with an SGSN 614, which monitors the location of GPRS terminals in the area of the GPRS network 620. The SGSN 614 also performs safety functions and supervises the network 620 access. The SGSN 614 also communicates with a GGSN 616, which functions as a link between the GPRS network 620 and external packet-switched networks 618. The SGSN 614 and the GGSN 616 communicate with each other by means of an IP-based backbone network.

FIG. 7 illustrates an arrangement of the terminal 600 and the telecommunication network 620 as a block diagram. The terminal comprises transceiver means 702 implementing a bidirectional radio connection to a wireless telecommunication network, such as a mobile communication network. The mobile station 600 also comprises a user interface 704 comprising, for instance, input means, e.g. a keyboard, and information display means, e.g. a liquid crystal display. In an embodiment, the mobile station 600 comprises means 706 for implementing the IP protocol. The means 706 for implementing the IP protocol can comprise protocol stacks for the IP protocol versions 4 and/or 6, for example. In an embodiment, the means 706 for implementing the IP protocol are configured to process the option field which is received in the Router Advertisement message of the Neighbor Discovery process of the IPv6 protocol and which contains pricing information concerning the use of the telecommunication network.

Furthermore, the mobile station 600 comprises a control unit 700, which coordinates different functions of the mobile station. The control unit 700 controls the operation of the transceiver 702 in receiving the pricing information, for instance. Furthermore, the control unit 700 communicates with the user interface 704 of the mobile station and controls the displaying of the pricing information of different networks to the user and the selection of the network, which is performed on the basis of the choices of the user. In accordance with an embodiment, the control unit 700 also controls the automatic network selection according to the price of data transmission. In addition, the control unit 700 can implement other procedures associated with the method of the invention. For instance, the control unit 700 can coordinate the connecting of the mobile station to different telecommunication networks. The control unit 700 thus receives the information on the networks in whose coverage area the terminal is and also on the prices of data transmission in these networks.

In an embodiment, the telecommunication network 620 comprises a transceiver 710, which implements a bidirectional radio connection to terminals within the coverage area of the network. The telecommunication network 620 also comprises means 712 for forming pricing information and providing it for the terminals. In an embodiment this means that in the IP version 6, means 714 for implementing the IP protocol add to the Router Advertisement message an option parameter indicating the price of using the network. In a second embodiment, the message according to the DHCP is provided with a corresponding new option parameter indicating the price of using the network. At each time, the price can be read in the telecommunication network from a separate database, for instance, where the price of data transmission can be stored according to price type and time of day, for example.

The invention can be implemented in a terminal and/or telecommunication network as software, ASIC (Application Specific Integrated Circuit) or separate logic components, for instance.

Although the invention is described above with reference to the example according to the accompanying drawings, it is obvious that the invention is not restricted thereto, but may be modified in a variety of ways within the attached claims.

1. A method of transmitting pricing information to a terminal using a wireless telecommunication network, comprising:
connecting the terminal to at least one wireless telecommunication network;
receiving at the terminal from at least one telecommunication network pricing information on using the telecommunication network for data transmission; and
deciding, on the basis of the pricing information received at the terminal, whether the telecommunication network is used for data transmission.

2. A method as claimed in claim 1, wherein the terminal displays the pricing information concerning data transmission in available telecommunication networks to the user of the terminal;
the terminal receives as input data the user's selection concerning the use of a telecommunication network;
the terminal establishes a connection to the telecommunication network the user has selected.

3. A method as claimed in claim 1, wherein
the terminal is connected to at least two wireless telecommunication networks; and
the terminal receives pricing information from the at least two telecommunication networks to which the terminal is connected.

4. A method as claimed in claim 3, wherein
the terminal starts the data transmission automatically in a telecommunication network, which, on the basis of the pricing information received from the at least two telecommunication networks, is the most inexpensive.

5. A method as claimed in claim 3, wherein when the terminal is in the data transmission connection with a first telecommunication network, the terminal receives the pricing information concerning the price of data transmission in a second telecommunication network to the coverage area of which the terminal has moved;
the terminal decides whether the data transmission connection is changed to the second telecommunication network, if the pricing information received from the second telecommunication network indicates that the second telecommunication network is more inexpensive than the first telecommunication network.

6. A method as claimed in claim 3, wherein when the terminal is in the data transmission connection with the first telecommunication network, the terminal receives the information that the connection to the first telecommunication network is broken;
the terminal decides whether the connection is changed to the second telecommunication network, from which pricing information is received, indicating that the second telecommunication network is more expensive than the first telecommunication network.

7. A method as claimed in claim 1, wherein when the terminal is in the data transmission connection with the telecommunication network, the terminal receives the information that the price of the data transmission connection has changed;
the terminal decides whether the data transmission connection is to be continued in the telecommunication network the price of which has changed.

8. A method as claimed in claim 1, wherein the pricing information comprises one or more following price parameters: pricing accuracy, pricing scope, pricing type, currency, monetary value.

9. A method as claimed in claim 1, wherein the telecommunication network applies IP (Internet Protocol), and the pricing information is transferred to the terminal in a message belonging to the IP.

10. A method as claimed in claim 9, wherein the pricing information is transferred as an option parameter of a Router Advertisement message belonging to the Neighbor Discovery process of the IPv6 protocol.

11. A method as claimed in claim 9, wherein the pricing information is transferred as an option parameter of a message according to DHCP (Dynamic Host Configuration Protocol).

12. An arrangement for providing a terminal with information on the price of using a wireless telecommunication network, comprising
at least one wireless telecommunication network, each telecommunication network comprising a transceiver for forming a radio connection to terminals in the coverage area of the telecommunication network,
a terminal, which is within the coverage area of said at least one telecommunication network, the terminal comprising a transceiver for forming a radio connection to the transceiver of at least one telecommunication network, wherein
the telecommunication network comprises means for forming pricing information on using the telecommunication network for data transmission;
the transceiver of the terminal is configured to receive from said at least one telecommunication network the pricing information on using the telecommunication network for data transmission, and
the terminal comprises a control unit controlling different parts of the terminal, the control unit being configured to form control information for selecting a telecommunication network to be used for data transmission on the basis of the pricing information received from said at least one telecommunication network.

13. An arrangement as claimed in claim 12, wherein the terminal comprises a user interface communicating with the control unit, the user interface being configured to:
display the pricing information concerning data transmission in available wireless telecommunication networks as control information to the user of the terminal;
receive as input data the user's selection concerning the telecommunication network the user wants to use; and
the control unit is configured to control the transceiver such that the transceiver establishes a connection to the telecommunication network the user has selected.

14. An arrangement as claimed in claim 12, wherein
the control unit is configured to control the transceiver so that it is connected to at least two wireless telecommunication networks; and
receive pricing information from at least two telecommunication networks to which the terminal is connected.

15. An arrangement as claimed in claim 14, wherein the control unit is configured to:
select from at least two telecommunication networks a telecommunication network which is more inexpensive, and
control the transceiver of the terminal to start the data transmission in the selected, more inexpensive telecommunication network.

16. An arrangement as claimed in claim 14, wherein when the transceiver of the terminal is in the data transmission connection with a first telecommunication network, the transceiver is configured to receive the pricing information concerning the price of data transmission in a second telecommunication network to the coverage area of which the terminal has moved;
the control unit of the terminal is configured to decide whether the data transmission connection is changed to the second telecommunication network, if the pricing information received from the second telecommunication network indicates that the second telecommunication network is more inexpensive than the first telecommunication network.

17. An arrangement as claimed in claim 14, wherein when the terminal is in the data transmission connection with the first wireless telecommunication network, the terminal is configured to receive the information that the connection to the first telecommunication network is broken; and
the control unit is configured to decide whether the connection is changed to the second telecommunication network, from which pricing information is received, indicating that the price of data transmission in the second telecommunication network is more expensive than in the first telecommunication network.

18. An arrangement as claimed in claim 12, wherein when the terminal is in the data transmission connection with the telecommunication network, the terminal is configured to receive the information that the price of the data transmission connection has changed; and
the control unit is configured to decide whether the data transmission connection is to be continued in the telecommunication network the price of which has changed.

19. An arrangement as claimed in claim 12, wherein the pricing information comprises one or more following price parameters: pricing accuracy, pricing scope, pricing type, currency, monetary value.

20. An arrangement as claimed in claim 12, wherein the wireless telecommunication network applies IP (Internet Protocol), and the telecommunication network is configured to transfer the pricing information to the terminal in a message belonging to the IP.

21. An arrangement as claimed in claim 20, wherein the telecommunication network is configured to transfer the pricing information as an option parameter of a Router Advertisement message belonging to the Neighbor Discovery process of the IPv6 protocol.

22. An arrangement as claimed in claim 20, wherein the telecommunication network is configured to transfer the pricing information as an option parameter of a message according to DHCP (Dynamic Host Configuration Protocol).

23. A terminal, comprising:
a transceiver for forming a radio connection to at least one wireless telecommunication network,
the transceiver being configured to receive from said at least one telecommunication network pricing information on using the telecommunication network for data transmission, and
the terminal comprises a control unit, the control unit being configured to form control information for selecting a telecommunication network to be used for data transmission on the basis of the pricing information received from said at least one telecommunication network.

24. A wireless telecommunication network, comprising
a transceiver for forming a radio connection to a terminal using the telecommunication network;
means for forming pricing information on using the telecommunication network for data transmission, and
the transceiver is configured to transmit the pricing information on using the telecommunication network for data transmission to the terminal in radio connection with the telecommunication network.
